(19) United States
(12) Patent Application Publication
(10) Pub. No.: US 2010/0282442 A1
(43) Pub. Date: Nov. 11, 2010

(54) STRUCTURAL SANDWICH PLATE PANELS AND METHODS OF MAKING THE SAME

(76) Inventor: Oleg Sukuvoy, Gerrards Cross (GB)

Correspondence Address: NIXON & VANDERHYE, PC, 901 NORTH GLEBE ROAD, 11TH FLOOR, ARLINGTON, VA, 22203, US

(21) Appl. No.: 12/811,444

(22) PCT Filed: Jan. 5, 2009
(86) PCT No.: PCT/GB09/00018

§ 371 Date: Jul. 1, 2010

(30) Foreign Application Priority Data
Jan. 7, 2008 (GB) 0800840.4

(51) Int. Cl. F28D 15/00; B29C 65/54; F28D 5/00

(52) U.S. Cl. 165/104.19; 156/60; 165/168; 392/496; 165/157

(57) ABSTRACT

The present application relates to a structural sandwich plate member comprising first and second outer metal plates and a core of plastics or polymer material bonded to the outer metal plates and arranged to transfer shear forces there between, wherein the member further comprises: a conduit for a temperature control medium, the conduit being embedded in the core and in thermal contact with at least one of the outer metal plates.

The present invention relates to structural sandwich panels, particularly for use in vessels, off-shore structures and buildings.

Marine applications put high demands on HVAC systems in order provide a high degree of indoor climate regardless of the climate zone in which the vessel is operating. Forced convection air-conditioning systems, which control indoor temperature by supplying cold or hot air, are most commonly used. A wide range of purpose built fans, ducting and air movement devices, air handling units with an automation and control system are installed in spaces onboard ships and platforms to provide an indoor climate that meets the required criteria, see for example BS EN ISO 7730:1995, “Moderate thermal environments. Determination of the PMV and PPD indices and specification of the conditions for thermal comfort”. Such systems have high costs in terms of materials, effort needed for installation, and reduction in the available usable space. As an example, a cruise ship measuring 223 metres long and 60 metres high with 16 decks and room for 2,750 passengers might require 60 air handling units, about 80 km of ducting, about 150,000 fittings and thousands of air terminal devices and air valves.

In on-shore buildings, so-called “radiant ceilings” have been proposed as an alternative to forced convection air-conditioning systems. In such a system, cool water is pumped through copper pipes attached to the non-visible side of false ceiling panels and the room below is cooled by absorption of radiant heat and convection. Radiant ceilings have various advantages over forced air systems but can become expensive to install and maintain if a large number of different panels is required.

It has also been proposed to cool buildings by flowing water through pipes embedded in concrete ceiling slabs, see for example Antonopoulos, K. A., et al, “Experimental and theoretical studies of space cooling using ceiling-embedded piping”, Applied Thermal Engineering Vol. 17, No. 4. pp 351-367, 1997 and “Numerical Solution of Unsteady Three-Dimensional Heat Transfer During Space Cooling Using Ceiling Embedded Piping” Energy Vol. 22 No. 1 pp 59-67, 1997. However, due to the high thermal mass and low thermal conductivity of the concrete slabs, several hours can be required to effect a temperature change in the room being cooled.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems may be used in many forms of construction to replace stiffened steel plates, formed steel plates, reinforced concrete or composite steel-concrete structures and greatly simplify the resultant structures, improving strength and structural performance (e.g. stiffness, damping characteristics) while saving weight. Further developments of these structural sandwich plate members are described in WO 2001/32414, also incorporated hereby by reference. As described therein, foam forms may be incorporated in the core layer to reduce weight and transverse metal shear plates may be added to improve stiffness.

According to the teachings of WO 2001/32414, the foam forms can be either hollow or solid. Hollow forms generate a greater weight reduction and are therefore advantageous. The forms described in that document are not confined to being made of light weight foam material and can also be made of other materials such as wood or steel boxes, plastic extruded shapes and hollow plastic spheres.

It is an aim of the present invention to provide a structural sandwich plate member incorporating arrangements for temperature conditioning in a vessel, off-shore structure, building or other structure.

According to the present invention, there is provided a structural sandwich plate member comprising first and second outer metal plates and a core of plastics or polymer material bonded to the outer metal plates and arranged to transfer shear forces therebetween, wherein the member further comprises:

a conduit for a temperature control medium, the conduit being embedded in the core and in thermal contact with at least one of the outer metal plates.

In an embodiment, the conduit may be a pipe or hose through which a thermal transfer fluid, acting as the temperature control medium, may be caused to flow so as to heat or cool the member. In a preferred embodiment, the thermal transfer fluid is a liquid, preferably water.

In another embodiment, the conduit is an electrical conductor and the temperature control medium is electric current whereby the member may be heated by electrical resistive or inductive heating.

The present invention also provides a method of manufacturing a structural sandwich plate member, comprising the steps of:

providing first and second metal plates in a spaced apart relationship so as to define a cavity;

providing a conduit for a temperature control medium in the cavity;

filling said cavity with uncured plastics or polymer material; and

allowing or causing said plastics or polymer material to cure to bond to said metal plates with sufficient strength to transfer shear forces therebetween.

The materials, dimensions and general properties of the outer plates of the structural sandwich plate member of the invention may be chosen as desired for the particular use to which the structural sandwich plate member is to be put and in general may be as described in U.S. Pat. No. 5,778,813 and U.S. Pat. No. 6,050,208. Steel or stainless steel is commonly used in thicknesses of 0.5 to 20 mm and aluminium may be used where low weight is desirable. Similarly, the plastics or polymer core may be any suitable material, for example an elastomer such as polyurethane, as described in U.S. Pat. No. 5,778,813 and U.S. Pat. No. 6,050,208 and is preferably compact, i.e. not a foam. The core is preferably a thermosetting material rather than thermoplastic.

The present invention will be described below with reference to exemplary embodiments and the accompanying schematic drawings, in which:

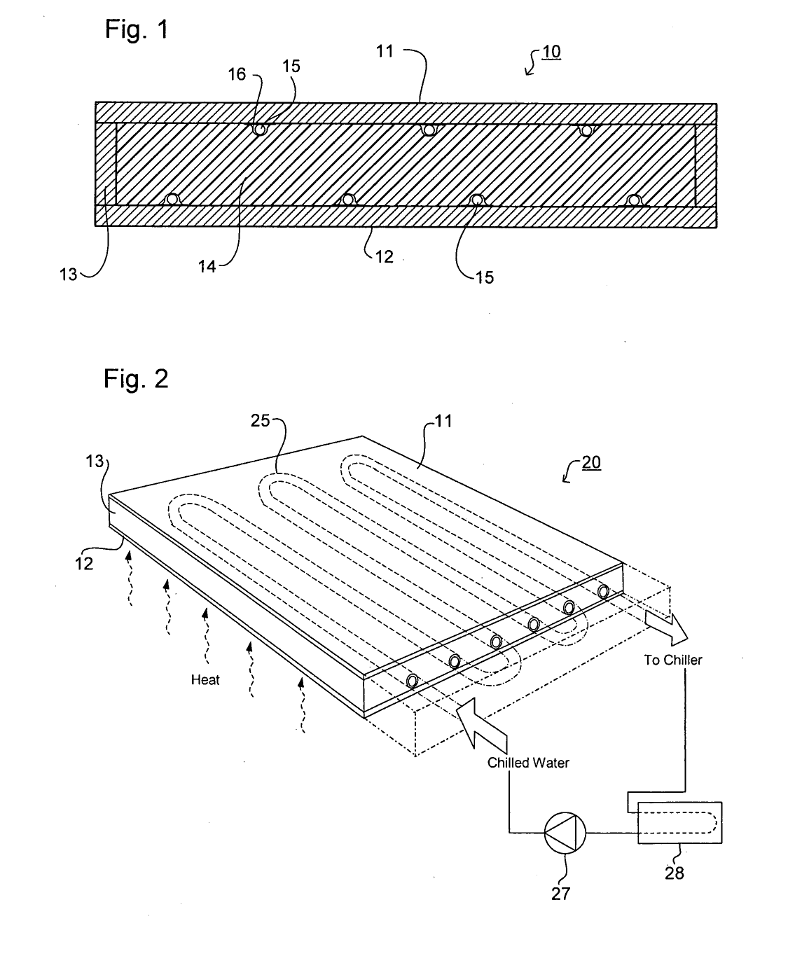

FIG. 1 is a cross-sectional view of a structural sandwich plate member according to an embodiment of the present invention;

FIG. 2 is a partly cut-away perspective view of another structural sandwich plate member according to an embodiment of the present invention; and

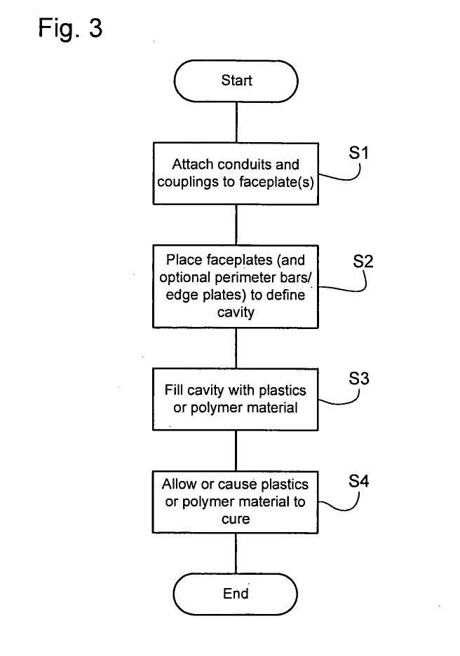

FIG. 3 is a flow diagram of a method of manufacturing a floor panel according the invention.

In the various drawings, like parts are indicated by like reference numerals.

The structural sandwich plate member (or panel) shown in FIG. 1 comprises upper and lower outer plates (faceplates) 11, 12 which may be of steel, aluminium or other metal and have a thickness, for example, in the range of from 0.5 to 8 mm, more preferably 1 to 5 mm, most preferably 1 to 2.5 mm. Edge plates, rolled structural shapes, extruded structural shapes, or perimeter bars 13 are provided between the face plates 11, 12 around their outer peripheries to form a closed cavity. In the cavity between the face plates 11, 12 is a core 14. This core may have a thickness in the range of from 15 to 200 mm; in many applications 25 to 100 mm is suitable. The overall dimensions of the plate member in plan may be from 1 to 5 m width by 5 to 15 m length. A preferred size is 2.5 m by 10 m. Plate members may be made in standard sizes or tailor-made to specific shapes and/or dimensions.

The core 14 comprises a plastics or polymer material (preferably a thermoset, compact elastomer such as polyurethane as discussed above) which is bonded to the faceplates 11, 12 with sufficient strength and has sufficient mechanical properties to transfer shear forces expected in use. The bond strength between the core 14 and face plates 11, 12 should be greater than 3 MPa, preferably greater than 6 MPa, and the modulus of elasticity of the core material should be greater than 200 MPa, preferably greater than 250 MPa. For low load applications, where the typical use and occupancy loads are of the order of 1.4 kPa to 7.2 kPa, the bond strength may be lower, e.g. approximately 1.0 MPa, but sufficient to provide the required resistance, based on safety indices associated with construction for all anticipated loads, including use and occupancy loads, construction loads and wind, earthquake (if appropriate) and temperature loads. By virtue of the core 14, the structural sandwich plate member has a strength and load bearing capacity of a stiffened steel plate having a substantially greater plate thickness and significant additional stiffening. The core layer 14 acts to transfer shear forces between the outer metal plates 11, 12.

Within core 14 are provided conduits 15 which are in thermal contact with one or both of outer metal plates 11, 12. Conduits 15 may be held to the outer metal plates 11, 12 by fixing devices such as brackets or clips 16, or by thermally conductive adhesives. It is also possible that the conduits be held in place simply by the core 14. The conduits are preferably in direct contact with the core 14. The purpose of the conduit 14 is to allow the temperature of the member or panel 10 to be controlled.

In a preferred embodiment, the conduits 15 comprise hoses or pipes through which a thermal transfer fluid may be circulated. The thermal transfer fluid, preferably water, is brought to the desired temperature by, for example, a boiler or chiller, and pumped through the conduits. The thermal transfer fluid may also be heated using waste heat from an engine, in a vessel, or a power generator. Heat is transferred to or from the metal plate of the member or panel 10 and hence to and from the adjacent space, e.g. a compartment or cabin in a vessel or a room in an on- or off-shore structure. The pipes or hoses 15 do not need to be particularly strong since they are supported and protected by the core 14 but should be fluid tight (e.g. non-corroding) and resistant to the thermal transfer medium (e.g. water tight) and preferably have a reasonably high thermal conductivity. The pipes or hoses 15 may be thin-walled polypropylene or copper pipes.

In another embodiment, useful if only heating is required, the conduits 15 may be electrically resistive conductors whereby heat is generated as current is caused to flow through the conductor. Such a system has the advantage that it can be easily and quickly controlled and, if multiple conduits are separately switchable, localised temperature control can easily be provided. Electrically resistive conductors may also be used in combination with hoses or pipes for circulation if in thermal transfer fluid.

Although FIG. 1 shows conduits 15, on the innersides of both faceplates 11, 12 it will be appreciated that the conduits may be provided on only the lower faceplate 12 or only the upper faceplate 11 dependent on the application. The multiple conduits shown in FIG. 1 may be separate, e.g. so that the flow of the temperature control medium is separately controllable through each, joined in a network, different parts of a single conduit, e.g. laid out in a meandering path; or a combination of these. It will be appreciated that separate control over the flow in separate conduits allows localised temperature control with the possibility either to maintain a uniform temperature inspite of localised heat loads or to provide areas of different temperature. In particular, the insulating properties of the core 14 allow the faceplates 11, 12 to be maintained at different temperatures.

In embodiments of the invention, parts of the material of the core 14 may be replaced by relatively lightweight forms, that is having a lower density than the plastics or polymer material of the rest of the core, in order to reduce the overall weight of the member 10. The forms may be hollow or solid, e.g. of foam, and any of various types as disclosed in WO 2001/32414, WO 2002/078948, WO 2003/101728, WO 2004/082928 and WO 2005/051645, which documents are hereby incorporated by reference. Given the increased insulative effect of the lightweight forms, such forms may be laid out in such a way as to assist the maintenance of separately controllable heating and/or cooling zones.

FIG. 2 illustrates a particular embodiment of the invention in which the panel 20 has a single pipe 25 laid out in a meander path across most of the area of the panel. Cool water as the temperature control medium is caused to flow, by pump 27 from chiller 28 and recycled to the chiller.

Connections to the pipe 25 can be made by push-fit connections in the edges of the panels, although connections through either of the major faces is possible, which may be located so as to allow the pipes is multiple panels to be connected together in series or parallel.

It will be appreciated that where a fluid, such as water, is used as the temperature control medium, the heating or cooling effect can be controlled by controlling either or both of the temperature of the fluid and the flow rate. In particular in the case of cooling this enables condensation to be avoided by maintaining the temperature of the panel above the dew point.

As a ceiling or floor panel, the plate preferably presents a generally flat lower or upper surface but the other surface need not be flat and either or both surfaces may be provided with recesses, trenches, grooves or openings to accommodate utility conduits and outlets. Either or both vertical and horizontal passages may also be provided within the floor panel for utility conduits.

A preferred method of manufacturing floor panels according to the invention is shown in FIG. 3. This is preferably performed off-site and involves:
attaching the conduits 15 to the metal plates 11, 12, S1;
placing the outer metal layers 11, 12 in a mould, with spacers to define a cavity, S2;
injecting liquid plastics or polymer material into the cavity through an injection port, S3; and
causing or allowing the plastics of polymer material to cure to form the core 14, S4.

Edge plates, perimeter bars or rolled or extruded structural shapes 13 may be provided around the edges of the panel. As discussed above, a preferred plastic or polymer material is a thermoset polyurethane elastomer which is formed by injecting a mixture of two components that react in the cavity to form the polyurethane. The result is compact, i.e. not a foam.

After curing, the injection ports and vent holes are filled, e.g. with threaded plugs, and ground flush with the surface of the outer metal plate. Multiple injection ports and vent holes may be provided to ensure complete filling.

Whilst the hoses or pipes 15 are supported and protected after formation of the core by the core so that they do not need to be particularly strong during use of the panel, they do need to be able to resist, or be protected from, pressures and temperatures arising during injection and curing of the core so that they are not damaged or crushed. This can be done by pressurizing the hoses or pipes 15 during the injection process with a suitable gas or liquid, such as air or water. Indeed in some circumstances it may be advantageous to circulate heated or cooled fluid through the hoses or pipes 16 during the injection and/or curing process in order to control the temperature of the core material during that process.

The conduits 15 may be attached to the faceplates 11, 12 in any convenient way, e.g. by brackets or clips 16 or by adhesive. In some cases the conduits 15 may be sufficiently strong or rigid that they can simply be placed on the bottom faceplate prior to injection. Save for connections, the conduits 15 do not generally need to be positioned with great accuracy.

If the panel is to be provided with recesses, grooves or openings, e.g. for utility conduits and outlets, or other surface features, such as fixing or lifting points, these are preferably formed in or on the outer metal plates prior to injection of the core. Grooves and other indentations can be formed by known techniques such as milling, cutting, bending, rolling and stamping as appropriate to the thickness of the plate and size of feature to be formed. Details can be attached by welding. Tubes to define passageways through the floor panel, e.g. for utility conduits, can be put in place prior to injection of the material to form core 14. It is also possible to form such features after injection and curing of the core 14, by coring for example, but in that case measures may need to be taken to ensure that the heat generated by activities such as welding does not deleteriously affect the core 13.

In some circumstances it may be possible to avoid the use of a mould by welding edge plate or perimeter bars to the outer metal plates so that the panel forms its own mould. In such a case, it may be necessary to provide restraints to prevent deformation of the outer metal plates due to the internal pressures experienced during injection and curing of core 14.

It should be noted that after the core 14 has cured, the faceplates and perimeter bars are bound together by the core 14 so that in some cases the fixing of the perimeter bars to the face plates need only be sufficient to withstand loads encountered during the injection and curing steps, and not necessarily loads encountered during use of the panel 10. To improve sealing of the cavity, gaskets or sealing strips can be provided between the edge plates or perimeter bars and face plates.

It will be appreciated that the above description is not intended to be limiting and that other modifications and variations fall within the scope of the present invention, which is defined by the appended claims.

1. A structural sandwich plate member comprising first and second outer metal plates and a core of plastics or polymer material bonded to the outer metal plates and arranged to transfer shear forces therebetween, wherein the member further comprises:
a conduit for a temperature control medium, the conduit being embedded in the core and in thermal contact with at least one of the outer metal plates.

2. A member according to claim 1 wherein the conduit is arranged in a meandering path in the core of the member.

3. A member according to claim 1, wherein the conduit is in direct contact with at least one of the outer metal plates.

4. A member according to claim 1, wherein the conduit is in direct contact with the first outer metal plate over a first part of its length and in direct contact with the second outer metal plate over a first part of its length, the first part being different than the second part.

5. A member according to claim 1, wherein the conduit is in direct contact with the first outer metal plate and further comprising a second conduit for a temperature control medium, the second conduit being embedded in the core and in direct contact with the second outer metal plate.

6. A member according to claim 1, further comprising at least one fixing member fixing the conduit to the one of the outer metal plates.

7. A member according to claim 1, wherein the conduit is a pipe or hose through which a thermal transfer fluid may be caused to flow so as to heat or cool the member.

8. A member according to claim 7 wherein the conduit is adapted to receive water as the thermal transfer fluid.

9. A member according to claim 1, wherein the conduit is an electrical conductor whereby the member may be heated by electric resistive heating.

10. A vessel or structure comprising a member according to claim 7, and a fluid circulating system arranged to circulate temperature controlled fluid through the conduit.

11. A vessel or structure comprising a member according to claim 9 and an electric power supply arranged to cause current to flow through the conduit.

12. A method of manufacturing a structural sandwich plate member, comprising the steps of:
providing first and second metal plates in a spaced apart relationship so as to define a cavity;
providing a conduit for a temperature control medium in the cavity;
filling said cavity with uncured plastics or polymer material; and
allowing or causing said plastics or polymer material to cure to bond to said metal plates with sufficient strength to transfer shear forces therebetween.

13. A method according to claim 12 wherein providing the conduit comprises fixing the conduit in direct contact with at least one of the first and second metal plates.
